(19) United States
(12) Patent Application Publication
(10) Pub. No.: US 2014/0224420 A1
(43) Pub. Date: Aug. 14, 2014

(54) Method and process to produce and attach air spacers

(71) Applicant: John Milner McCary, Birmingham, AL (US)

(72) Inventor: John Milner McCary, Birmingham, AL (US)

(21) Appl. No.: 13/815,244

(22) Filed: Feb. 13, 2013

(51) Int. Cl. B32B 38/00

(52) U.S. Cl. CPC B32B 38/0004
USPC 156/269

(57) ABSTRACT

The invention entails the method and process to manufacture air spacers in a radiant reflective insulating, air and moisture vapor venting assembly. An adhesive mixture usually made up of ground wood, various types of binder resins such as formaldehyde based resins, and possibly other materials. The adhesive mixture is applied on various protective layers such as panels, which might be oriented strand board (OSB), plywood or even metal panels, or may be applied to more flexible protective layers such as synthetic style underlayment rolled material. The adhesive mixture is applied on the protective layer as parallel spaced lines approximately 1¼ to 1⅜^{th} inches apart, about ⅝ to 1 inch high and 1/16 to ⅛^{th} inch wide. Forming guides may be used to help form the adhesive mixture air spacer lines. Radiant reflective material is then adhered to the top edges of the mixture lines.

### CROSS-REFERENCE TO RELATED APPLICATIONS

This application has cross-reference to U.S. C.I.P patent application No.: U.S. Ser. No. 13/507,797, filed on Jul. 30, 2012.

### BACKGROUND OF THE INVENTION

Radiant venting and venting assemblies are comprised of protective, sometimes fairly rigid, protective upper layer, a non-collapsing columns or air spacers adhered to the underneath of the protective layer and the other ends of the air spacers adhered usually to radiant reflective material or film. The upper protective layer is held separated approximately ⅝ths to 1 inch from the radiant reflective layer by the attached air spacers, creating the needed air space for effective radiant heat reflection. When the radiant reflective insulating assembly is used under roofing or exterior wall coverings, such as sidings, brick or stucco, the upper protective layer may be rigid enough to perform as roof or wall sheathing with the air spacers being strong and stiff enough to resist collapsing under roofing or wall or wall siding applications, with the air spacers maintaining the air space for efficient radiant heat reflection. The air spacers would need to be stiff enough to maintain the radiant/venting air space even under roof loading and usual roof foot traffic. Additionally the non-collapsing air spacers can allow for venting air and moisture,

The difficulty of producing the radiant reflective assembly is being able to efficiently and economically produce and adhere the ends of the air spacers to the underside of the protective layer and to the radiant reflective layer. The air spacers also need to become strong and stiff enough to not collapse under roofing and wall covering applications. The finished and hardened air spacers need to be of the desired adhered shape. What is needed is a manufacturing method and process to produce the desired shaped adhered air spacers between the protective layer and the radiant reflective film/material.

### SUMMARY OF THE INVENTION

The present invention is a method and process to efficiently and economically produce the air spacers of a radiant insulating, venting and moisture and air venting assembly, similar to as described in U.S. Pat. No. 8,291,660 and C I P patent application No.: U.S. Ser. No. 13/507,797, filed Jul. 30, 2012. The air spacers produced under the manufacturing method and process have the desired finished hardened shape and stiff enough to not collapse under roofing and wall siding applications.

One embodiment of the present invention of a method and process to produce the air spacers is in a panel manufacturing or processing facility such as in an oriented strand board (OSB) or plywood plant where individual panels are conveyed in a moving process line edge to edge under a die head or spray line. A composition of ground wood mixed with resins and possible other binders (the mixture) is placed in continuous parallel lines through the die heads or spray line. The mixture's composition enables it to stick to the panels due to the mixture's adhesive qualities. The resins in the mixture are usually formaldehyde based resins or possibly a methylene diphenyl di-isocyanate type resins, which would have good adhesive qualities. The laid down parallel lines are spaced approximately about 1¼ to 1⅜ths inch apart; are about ⅛^{th} inch thick where the lines are touching the panels; are about ¾ inch high, tapered about 1/16^{th} to ⅛^{th} inch at the top edge of the parallel lines.

Forming guides are usually used on either side of each line as the mixture placed line is first laid down on the panels. The forming guides help hold the mixture lines in the desired shape as the panel moves down the conveyer line. A release agent may be applied to the interior sides of the forming guides to assist in releasing the formed line from the forming guides. It is important that the release agent does not interfere with the formed lines adherence to the panel's surface. Radiant reflective material or film (usually in roll form) may be placed (unrolled) on the top edges of the line as the panels move down the conveyer line. At this point in the manufacturing process the forming guides may tapper down in height in relation to the height of the line where the radiant reflective film is adhered to the top edge of the mixture line. The composition of the line mixture allows the mixture to be able to adhere to the surface of the radiant reflective material/film. After the radiant reflective material/film is adhered to the mixture line the forming guides are released or are separated from the mixture line and non-compression guides start in-between each line, not usually touching the mixture line, that touch the radiant reflective film/material, keeping the weight of radiant reflective film/material from collapsing the mixture line air spacer beyond the desired designed height of ⅝ths to ¾ inch. The non-compression guides also helps to keep the surface top edge width mixture line connection point to the radiant reflective film surface to the desired minimum. When the mixture line hardens to the desired point becoming hardened air spacers, a cutting device cuts perpendicular to the air spacer, plus cutting the radiant reflective material, at the edges of the panel.

The continued strength and stiffness of the air spacers developed in the radiant reflective air and moisture venting panel assembly allows the assembly to be used such as roof sheathing where the air spacers would not collapse when attached to rafters or purlins (rafter cross members usually used in metal roofs). Also if rigid foam spray is applied to the under roof side of the radiant reflective material/film, the radiant reflective material/film would not detach to any significant degree from the air spacers.

Another embodiment of the air spacer production process in a radiant insulating, venting and moisture and air venting assembly is when the air spacers are applied to a synthetic underlayment protective layer. As slip resistant synthetic underlayment style sheeting, usually made of woven polypropylene or other polymers, is rolled out along a process moving conveyer line with the adhesive composition mixture usually of ground wood and resin binders, such as formaldehyde based resins or methylene diphenyl di-isocyanate, are laid out in parallel lines by a die head or spray head perpendicular to the length of the rolled out synthetic underlayment. The composition mixture is placed into mixture line forming guides which are placed perpendicular to the rolled out length on the synthetic underlayment. The line mixture is filled into the forming guides, which are closed off at each end to not let the line mixture flow out each end of the guide. The forming guides may not run the full width of the underlayment but rather may leave a small longitudinal end section or overlap tab, free of the formed mixture line. The line mixture forming guides move along parallel to each other and laterally down the process line at the same speed as the synthetic underlayment. The forming guides are designed and shaped to allow a certain amount of line mixture to cover and be formed on most of the entire surface (surface mixture) of the synthetic underlayment. The surface mixture is usually thicker nearest the mixture lines and usually tappers to a thinner at a point between the two mixture lines. When the line/surface mixture hardens to the desired rate the forming guides are lifted up vertically and then are moved in a circular motion back to the point on the process line and placed on the synthetic underlayment at the original point that they were first filled with the line/surface mixture and the repeated process of the forming guides moving down laterally with the filled line mixture is continually performed.

Once the line/surface mixture is free of the forming guides, radiant reflective material, usually unrolled reflective film, is placed upon the top edges of the line mixture and is adhered to the line mixture usually by the remaining adhesiveness of the line mixture. As the line/surface mixture hardens further at a certain point on the process line the protective layer, now composed of the synthetic underlayment and the added surface mixture, the mixture line hardened air spacers and the reflective material/film is cut leaving the radiant reflective and venting assembly a desired length. The assembly is then rolled up with the now somewhat rigid protective layer being on the outside of the roll. The tapered hardened surface mixtures center points between each column air spacer are flexible enough to allow the protective layer to bend at the surface mixture center point lines.

When the radiant reflective and venting underlayment assembly might be used in a roofing application the assembly is rolled out upon the roof sheathing with the protective layer facing up. The protective layer's overlap tab, portion or continued lateral strip of synthetic underlayment where the line/surface mixture was not placed on synthetic underlayment, is placed on the downward slope edge of the rolled out parallel to the roof edge radiant reflective and venting underlayment assembly. The radiant reflective underlayment is adhered to the roof with usually nails or staples. The next proceeding row of the radiant reflective underlayment is placed up-slope and parallel to the preceding radiant reflective underlayment with its overlap tab being placed over the up-slope edge of the preceding radiant reflective underlayment row. The overlap tab helps to keep moisture from flowing down between the edges of the radiant reflective underlayment. The radiant reflective and venting underlayment is strong enough for roofing to be nailed, screwed, or stapled through the radiant reflective underlayment to the roof sheathing, or possible purlins, and the radiant reflective and venting underlayment not collapsing due to the air spacers manufacturing process. Also when the underside of the roof sheathing is sprayed with rigid foam insulation, or other material, that would block under roof venting, the radiant reflective underlayment's air/moisture vapor venting capabilities can be used due to stability and strength developed in the air spacer's manufacturing process.

### BRIEF DESCRIPTION OF THE DRAWINGS

FIG. 1 shows in an overhead perspective view a panel radiant reflective assembly air spacer production line.

FIG. 2 in an overhead perspective view shows a synthetic style underlayment radiant reflective assembly air spacer production line.

FIG. 3 shows in a side view a synthetic style underlayment radiant reflective assembly with produced air spacers being rolled up.

### DETAILED DESCRIPTION OF THE PREFERED EMBODIMENTS

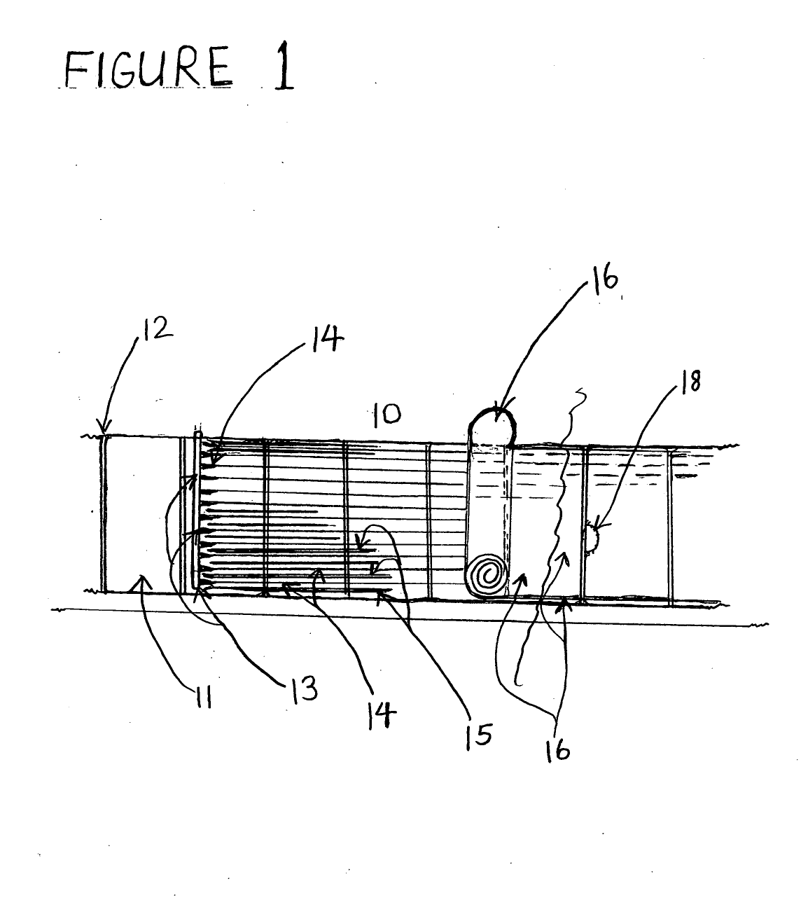

Shown in FIG. 1. is an overhead perspective view of a panel radiant reflective air spacer production line 10. Panels 11, such as oriented strand board (OSB) or plywood, move down the production line 10 with the panel's butted longwise edge to edge 12. An adhesive mixture, usually made up of ground wood, usually with various binder resins and some other materials is die or spray head applied 13 and are adhered by the adhesiveness of the composition adhesive mixture to the moving panels 11 in parallel spaced apart adhesive mixture, to be formed, air spacer lines 14. Forming guides 15 are usually used to help support and shape the mixture lines 14. As the mixture line air spacers harden radiant reflective material/film 16 adhered to the top edges of the mixture lines. When the air spacer mixture lines further hardens the panels, along with the parallel column line air spacers 17 and the radiant reflective material 16, are separated by a cutting device 18.

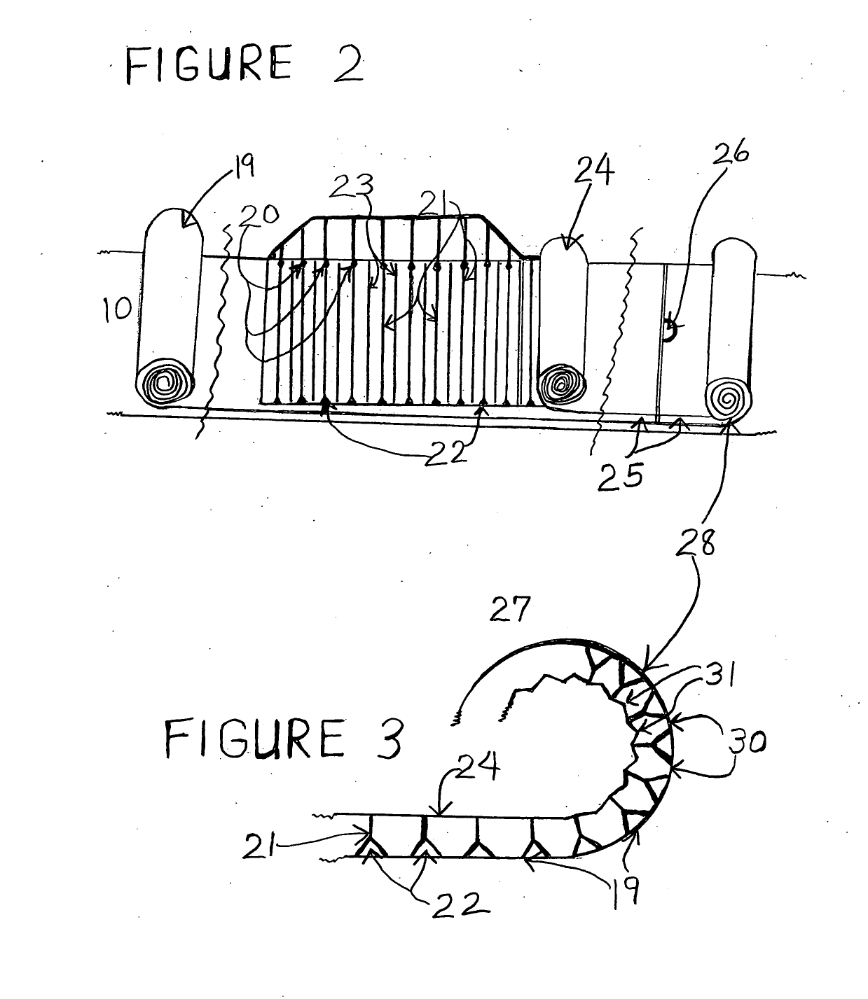

FIG. 2. in an overhead perspective view shows synthetic style underlayment 19 unrolled in a radiant reflective assembly air spacer production line 10. An adhesive mixture, usually composed of ground wood, binder resins and possibly other materials is applied by die or spray heads 20 on the moving rolled out synthetic style underlayment 19, in parallel spaced apart to be formed air spacer lines 21 and tapered surface mixture layers 22, which give strength and stiffness to the protective underlayment style layer 19. Forming guides 23 are used to help form the shape of the adhesive mixture air spacer lines 21 and tapered surface mixture layer 22. Radiant reflective material/film 24 is then adhered to the top edges of the air spacer lines 21. A cutting device 25 cuts the synthetic style underlayment radiant reflective assembly 26 into the desired length and then the radiant reflective assembly is rolled up 27.

Shown in FIG. 3., in a side view, is the rolled up synthetic style underlayment radiant reflective assembly 26 showing the produced air spacer vertical lines or columns 21 and the formed tapered surface adhesive mixture layers 22 which gives surface strength and stiffness to the synthetic underlayment/adhesive mixture protective layer 28. As the radiant reflective assembly 26 is rolled up the protective layer is able to flex and bend at the mid thin point 29 of the surface mixture tapered layers 22 and the radiant reflective material/film 24 folds inward 30 toward the synthetic style underlayment/surface mixture protective layer 22.

1. A method and process to produce and attach air spacers, compromising:
a. an adhesive composition mixture usually made up of ground wood and resin binders, such as formaldehyde based resins or methlylene diphenyl di-isocyanate, plus possibly other materials, is produced; and
b. a moving process line of a protective layer panels, such as oriented strand board (OSB), synthetic style underlayment or metal panels; and
c. die or spray heads apply the adhesive composition mixture to the panels or synthetic style underlayment in parallel mixture lines, or forming air spacers, approximately 1¼ to 1⅜ths inches apart, 1/16 to ⅛^{th} inches wide and ⅝ths to 1 inch high; and
d. the adhesiveness of the adhesive composition mixture allows the adhesive composition mixture to adhere to the panels or synthetic style underlayment; and
e. forming guides may be used help form the mixture into the desired designed shape, and
f. radiant reflective material/film may be adhered to the top edges of the mixture line usually by the remaining adhesiveness of the mixture line; and
g. when the composition adhesive mixture hardens to the desired stiffness the panel's air spacers and radiant reflective material/film is cut at the edges of the panels, separating the panels, or the synthetic style underlayment radiant reflective and venting assembly is cut to the desired length.

2. A method and process to produce and attach air spacers according to claim 1, where the adhesive composition mixture is developed and applied under pressure and/or heat created by grinding such as by a conical co-rotating grinder or extruder.

3. A method and process to produce and attach air spacers according to claim 1, where heat is added to the adhesive composition mixture before being applied by the die or spray heads.

4. A method and process to produce and attach air spacers, according to claim 1, where a release agent may be applied to sections of the forming guide to help release the adhesive composition mixture from the forming guides.

5. A method and process to produce and attach air spacers, according to claim 1, where the protective layer are panels such as oriented strand board (OSB) or plywood; and
a. the panels move individually down the process line edge to edge lengthwise, and b. the form guide's height tapers down to allow the radiant reflective material/film to touch and adhere to the line mixture; and
c. a non-collapse guide may be used that lies between, and does not touch, the mixture line to keep the weight of the adhered radiant reflective material/film from collapsing the height of the mixture line and to keep the surface top edge width mixture line connection point to the radiant reflective film surface to the desired minimum; and
d. when the mixture line hardens to the desired point a cutting device cuts perpendicular to the mixture line along with the radiant reflective material, at the edge of the finished panel.

6. A method and process to produce and attach air spacers, according to claim 1, where a synthetic underlayment style material is rolled out in a process line; and
a. the composition mixture is placed into mixture line forming guides which are placed perpendicular to the rolled out length on the synthetic underlayment material, and
b. the line mixture is filled into the forming guides, which are closed off at each end to not let the line mixture flow out each end of the guide; and
c. the forming guides may not run the full width of the underlayment material but rather may leave a small longitudinal end section or overlap tab, free of the formed mixture line, and
d. the line mixture forming guides move along parallel to each other parallel to each other and laterally down the process line at the same speed as the synthetic underlayment, and
e. the forming guides are designed and shaped to allow a certain amount of line mixture to cover and be formed on most of the entire surface (surface mixture) of the synthetic underlayment; and
f. the surface mixture is usually thicker nearest the mixture lines and usually tappers to a thinner at a point between the two mixture lines; and
g. when the line/surface mixture hardens to the desired rate the forming guides are lifted up vertically and then are moved in a circular motion back to the point on the process line and placed on the synthetic underlayment at the original point that they were first filled with the line/surface mixture and the repeated process of the forming guides moving down laterally with the filled line mixture is continually performed; and
h. once the line/surface mixture is free of the forming guides, radiant reflective material, usually unrolled reflective film, is placed upon the top edges of the line mixture and is adhered to the line mixture usually by the remaining adhesiveness of the line mixture; and
i. as the line/surface mixture hardens further at a certain point on the process line the protective layer, now composed of the synthetic underlayment and the added surface mixture, the mixture line and the reflective material/film is cut leaving the radiant reflective and venting assembly a desired length; and
j. the assembly is then rolled up with the now somewhat rigid protective layer being on the outside of the roll with the tapered surface mixtures center points between each mixture line being flexible enough to allow the protective layer to bend at these surface mixture center points.
